(19) United States
(12) Patent Application Publication
(10) Pub. No.: US 2019/0238009 A1
(43) Pub. Date: Aug. 1, 2019

(54) STATOR FOR ROTARY ELECTRIC MACHINE

(71) Applicant: HONDA MOTOR CO., LTD., Tokyo (JP)

(72) Inventor: Toru NAKAMURA, Saitama (JP)

(73) Assignee: HONDA MOTOR CO., LTD., Tokyo (JP)

(21) Appl. No.: 16/256,018

(22) Filed: Jan. 24, 2019

(30) Foreign Application Priority Data
Jan. 30, 2018 (JP) 2018-014095

(51) Int. Cl. H02K 1/20; H02K 9/193

(52) U.S. Cl. CPC H02K 1/20; H02K 9/193

(57) ABSTRACT

A stator for a rotary electric machine includes: a stator core; and a housing for accommodating the stator core. An outer circumferential surface of the stator core is covered with a coating portion having non-water permeability, a pair of sealing portions are provided between the coating portion and an inner circumferential surface of the housing and on both end sides in an axial direction, and a coolant flow path is formed by the coating portion, the inner circumferential surface of the housing, and the pair of sealing portions.

### CROSS-REFERENCE TO RELATED APPLICATIONS

The present application claims the benefit of priority of Japanese Patent Application No, 2018-014095, filed on Jan. 30, 2018, the content of which is incorporated herein by reference.

### TECHNICAL FIELD

The present invention relates to a stator for a rotary electric machine.

### BACKGROUND ART

A stator for a rotary electric machine is constituted by winding a coil around a stator core. The stator is generally cooled by a coolant because the temperature of the stator rises when the rotary electric machine operates. As illustrated in FIG. 4, in a water-cooled-type rotary electric machine 100, a stator housing 102 having a water jacket WJ is provided on an outer circumferential side of a stator core 101 and cooling is performed by making a coolant such as cooling water flow through the water jacket WJ. In the related art, the water jacket WJ of the stator housing 102 is manufactured by casting using a core (for example, JP-A-2017-143697). However, according to this manufacturing method, labor and time are required, which is a problem in terms of productivity and cost.

For this reason, a proposal has been proposed in which a stator housing is divided into two parts and a water jacket is formed by combining the two parts. Specifically, as illustrated in FIG. 5, in a rotary electric machine 200 of the related art, a stator housing 202 is divided into a housing base 202a on an outer circumferential side of a stator core 201 and a stator holder 202b for holding the stator core 201. The housing base 202a constitutes an outer circumferential portion of the water jacket WJ and one end side wall portion; the stator holder 202b constitutes an inner circumferential portion of the water jacket WJ and the other end side wall portion; and further, a portion between the housing base 202a and the stator holder 202b is sealed by a pair of sealing portions 204.

However, in the rotary electric machine of the related art illustrated in FIG. 5, it is necessary to shrink-fit the stator core 201 to the stator holder 202b or to press-fit the stator core 201 into the stator holder 202b. Dedicated equipment is required to shrink-fit the stator core 201 to the stator holder 202b, and thus productivity is low. In addition, when an outer circumferential surface of the stator core 201 is press-fitted by contacting with an inner circumferential surface of the stator holder 202b, the thickness of the stator holder 202b needs to be thick to withstand the press-fitting of the stator core 201, and thus there is a concern that the cooling performance deteriorates.

### SUMMARY

An object of the invention is to provide a stator for a rotary electric machine which has excellent productivity and high cooling performance.

According to a stator for a rotary electric machine including: a stator core; and a housing for accommodating the stator core, wherein: an outer circumferential surface of the stator core is covered with a coating portion having non-water permeability; a pair of sealing portions are provided between the coating portion and an inner circumferential surface of the housing and on both end sides in an axial direction; and a coolant flow path is formed by the coating portion, the inner circumferential surface of the housing, and the pair of sealing portions.

### EFFECTS

According to the present invention, since a coolant flow path is formed by a coating portion which has non-water permeability and covers the outer circumferential surface of a stator core, the inner circumferential surface of a housing, and a pair of sealing portions, it is possible to properly cool the stator core from the outer circumferential side thereof. Further, since a core structure of the housing is not necessary at the time of manufacturing and the stator core does not need to be shrink-fitted to the stator holder, productivity can be improved. Also, since it is sufficient as long as the housing satisfies the press-fitting strength against the pair of sealing portions, the thickness of the housing or the stator holder can be made thinner as compared with a case where the outer circumferential surface of the stator core is press-fitted by contacting with the inner circumferential surface of the housing or the inner circumferential surface of the stator holder. Therefore, the cooling performance is improved.

### BRIEF DESCRIPTION OF E DRAWINGS

FIG. 1 is a cross-sectional view of a main part of a stator for a rotary electric machine according to an embodiment of the present invention;

FIG. 2 is a cross-sectional view of a main part of a stator for a rotary electric machine of a first modification example;

FIG. 3 is a cross-sectional view of a main part of a stator for a rotary electric machine of a second modification example;

FIG. 4 is a cross-sectional view of a rotary electric machine of the related art which includes a water jacket manufactured by casting using a core; and

FIG. 5 is a cross-sectional view of a rotary electric machine of the related art which includes a water jacket manufactured by dividing a stator housing into two parts.

### DETAILED DESCRIPTION OF EMBODIMENT

Hereinafter, a stator for a rotary electric machine according to an embodiment of the present invention will be described with reference to the drawings.

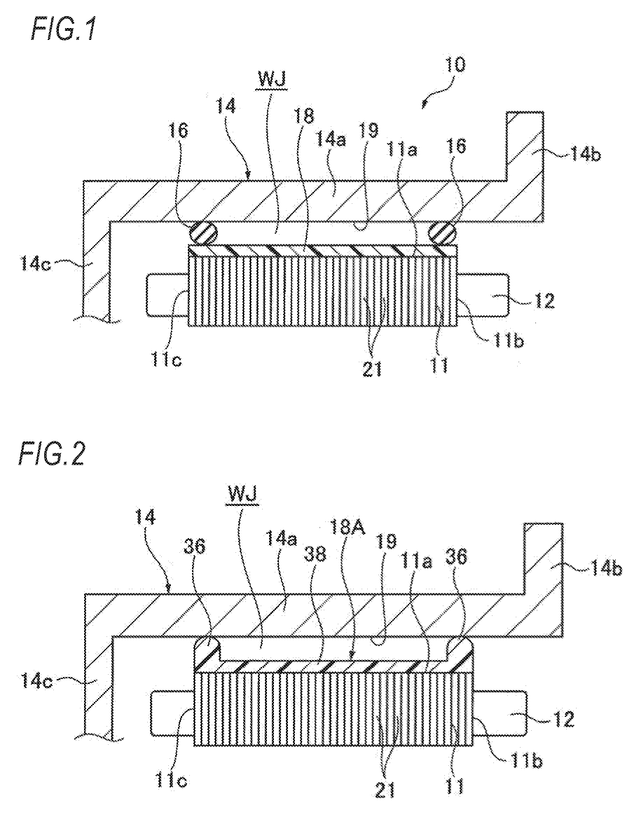

As illustrated in FIG. 1, a stator 10 for a rotary electric machine of the embodiment includes a stator core 11 having an annular shape, a coil 12 attached to the stator core 11, a housing 14 for accommodating the stator core 11 and the coil 12, and a pair of sealing portions 16 for sealing a space formed between the stator core 11 and the housing 14.

The housing 14 is a bottomed cylindrical member and includes a cylindrical portion 14a, an outward flange portion 14b extending radially outward from an end portion of the cylindrical portion 14a on one end side, and a bottom portion 14c extending radially inward from an end portion of the cylindrical portion 14a on the other end side.

The stator core 11 is constituted by laminating a plurality of steel plates 21 having an annular shape in an axial direction and an outer circumferential surface 11a thereof is covered with a coating portion 18 having non-water permeability. The coating portion 18 is made of a resin or rubber and is molded on the outer circumferential surface 11a of the stator core 11. In the axial direction, coil ends of the coil 12 protrude from one end surface 11 b and the other end surface 1 is of the stator core 11.

The sealing portions 16 are, for example, O-rings and arranged at both end portions of the coating portion 18 covering the outer circumferential surface 11a of the stator core 11 in the axial direction to seal a portion between the coating portion 18 covering the outer circumferential surface 11a of the stator core 11 and an inner circumferential surface 19 of the cylindrical portion 14a of the housing 14. The stator core is press-fitted to the inner circumferential surface 19 of the housing 14 in a state where the pair of sealing portions 16 are attached to the coating portion 18 by adhesion or the like.

In the stator 10 for the rotary electric machine constituted as described above, a water jacket WJ is formed on an outer circumferential side of the stator core 11 by the coating portion 18, the inner circumferential surface 19 of the housing 14, and the pair of sealing portions 16. Therefore, the stator core 11 is cooled from the outer circumferential side thereof by supplying a coolant (for example, cooling water, cooling oil, and ATF) to the water jacket WJ from a coolant supply portion (not illustrated).

Further, since the stator core 11 is press-fitted to the inner circumferential surface 19 of the housing 14 in a state where the pair of sealing portions 16 are attached to the outer circumferential surface 11a of the stator core 11 by adhesion or the like, a core structure of a housing is not necessary at the time of manufacturing as in a case of the related art. Since it is not necessary to shrink-fit a stator core to a stator holder, productivity can be improved.

Further, since it is sufficient as long as the housing 14 satisfies the press-fitting strength against the pair of sealing portions 16, the thickness of the housing 14 can be made thinner as compared with a case where the outer circumferential surface 11a of the stator core 11 is press-fitted by contacting with the inner circumferential surface 19 of the housing 14. Therefore, the cooling performance is improved.

Also, the coating portion 18 is made of a resin or rubber and molded on the outer circumferential surface 11a of the stator core 11. Therefore, the thickness of the coating portion 18 can be made thin and it is possible to reliably prevent the coolant from permeating into the stator core 11.

Further, in the stator 10 for the rotary electric machine illustrated in FIG. 1, the coating portion 18 and the pair of sealing portions 16 are separate bodies. However, as illustrated in FIG. 2, a sealing integral coating portion 18A integrally molded may be used. The sealing integral coating portion 18A is made of a resin or rubber and includes a coating portion 38 which covers the outer circumferential surface 11a of the stator core 11 and a pair of sealing portions 36 which are arranged at both end portions of the coating portion 38 and seal a portion between the coating portion 38 and the inner circumferential surface 19 of the housing 14.

In this way, the number of parts can be reduced by using the sealing integral coating portion 18A and it is not necessary to perform positioning between the coating portion 18 and the pair of sealing portions 16.

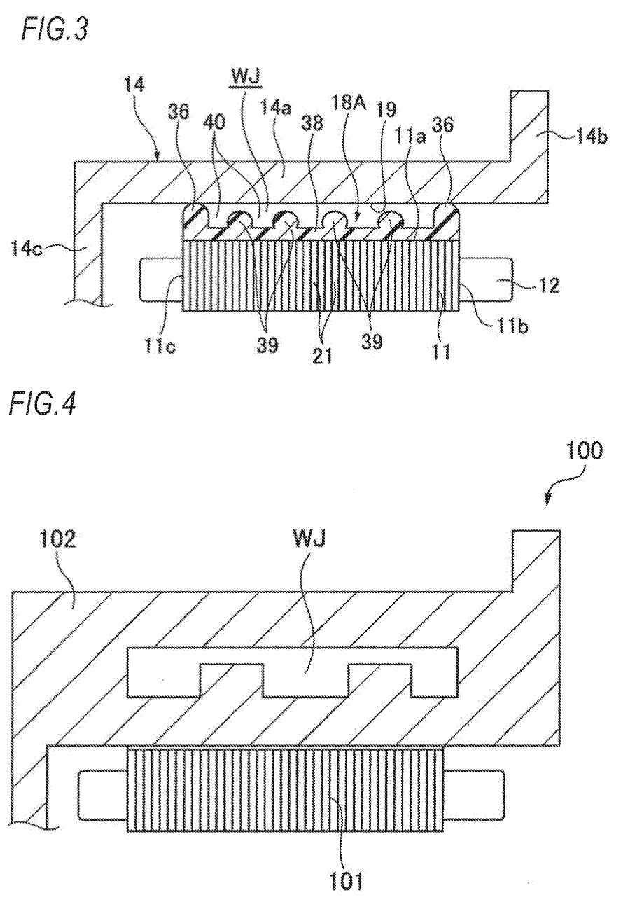

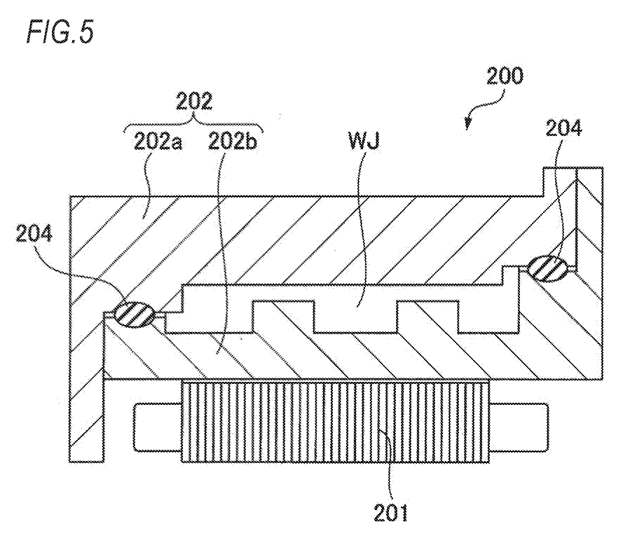

As illustrated in FIG. 3, in the sealing integral coating portion 18A, a protrusion portion 39 protruding toward an outer diameter side may be provided on an outer circumferential surface of the coating portion 38. At least one protrusion portion 39 is provided between the pair of sealing portions 36. A flow path 40 is formed in the water jacket WJ by the protrusion portion 39. The flow path 40 can make the coolant flow from one axial end side to the other axial end side whiling flow in a circumferential direction of the stator core 11 by forming the flow path 30, for example, in a spiral shape, and thus it is possible to properly cool the entire area of the stator core 11 in the axial and circumferential directions. Further, a plurality of flow paths 40 may be divided in the axial direction by a plurality of protrusion portions 39.

The invention is not limited to the embodiment described above, and appropriate modifications, improvement, or the like can be made.

At least the following matters are described in this specification. Although the corresponding constituent elements and the likes in the embodiments described above are described in parentheses, the present invention is not limited thereto.

(1) A stator (stator 10) for a rotary electric machine including:

a stator core (stator core 11); and

a housing (housing 14) for accommodating the stator core, in which

an outer circumferential surface (outer circumferential surface 11a) of the stator core is covered with a coating portion (coating portion 18 and sealing integral coating portion 18A) having non-water permeability,

a pair of sealing portions (sealing portions 16 and sealing portions 36) are provided between the coating portion and an inner circumferential surface (inner circumferential surface 19) of the housing and on both end sides in an axial direction, and

a coolant flow path (water jacket WJ) is formed by the coating portion, the inner circumferential surface of the housing, and the pair of sealing portions.

According to (1), since the coolant flow path is formed by the coating portion which has non-water permeability and covers the outer circumferential surface of the stator core, the inner circumferential surface of the housing, and the pair of sealing portions, it is possible to properly cool the stator core from the outer circumferential side thereof. Further, since a core structure of the housing is not necessary and the stator core does not need to be shrink-fitted to the stator holder, productivity can be improved. Also, since it is sufficient as long as the housing satisfies the press-fitting strength against the pair of sealing portions, the thickness of the housing or the stator holder can be made thinner as compared with a case where the outer circumferential surface of the stator core is press-fitted by contacting with the inner circumferential surface of the housing or the inner circumferential surface of the stator holder. Therefore, the cooling performance is improved.

(2) The stator for a rotary electric machine according to (1), in which the coating portion is made of a resin or rubber and is molded on the outer circumferential surface of the stator core.

According to (2), since the coating portion made of a resin or rubber is molded on the outer circumferential surface of the stator core, the thickness of the coating portion can be made thinner and it is possible to reliably prevent the coolant from permeating into the stator core.

(3) The stator for a rotary electric machine according to (1) or (2), in which the coating portion and the pair of sealing portions are integrally molded.

According to (3), since the coating portion and the pair of sealing portion are integrally molded, the number of parts can be reduced and it is not necessary to perform positioning between the coating portion and the pair of sealing portions.

(4) The stator for a rotary electric machine according to (3), in which the coating portion includes a protrusion portion (protrusion portion 39) which protrudes from the outer circumferential surface between the pair of sealing portions in the axial direction.

According to (4), since the coating portion includes the protrusion portion protruding from the outer circumferential surface between the pair of sealing portions, the surface area increases thereby increasing the cooling efficiency.

(5) The stator for a rotary electric machine according to (4), in which a flow path (flow path 40) of a spiral shape is formed in the coolant flow path by the protrusion portion.

According to (5), since the flow path of a spiral shape is formed in the coolant flow path by the protrusion portion, the flow of the coolant is regulated, and thus the coolant can be properly induced.

1. A stator for a rotary electric machine comprising:
a stator core; and
a housing for accommodating the stator core, wherein:
an outer circumferential surface of the stator core is covered with a coating portion having non-water permeability;
a pair of sealing portions are provided between the coating portion and an inner circumferential surface of the housing and on both end sides in an axial direction; and
a coolant flow path is formed by the coating portion, the inner circumferential surface of the housing, and the pair of sealing portions.

2. The stator for a rotary electric machine according to claim 1, wherein
the coating portion is made of a resin or rubber and is molded on the outer circumferential surface of the stator core.

3. The stator for a rotary electric machine according to claim 1, wherein
the coating portion and the pair of sealing portions are integrally molded.

4. The stator for a rotary electric machine according to claim 3, wherein
the coating portion includes a protrusion portion which protrudes from the outer circumferential surface between the pair of sealing portions in the axial direction.

5. The stator for a rotary electric machine according to claim 4, wherein
a flow path of a spiral shape is formed in the coolant flow path by the protrusion portion.
